(19) United States
(12) Patent Application Publication
(10) Pub. No.: US 2013/0028055 A1
(43) Pub. Date: Jan. 31, 2013

(54) HIGH DIRECTIVE ULTRASONIC TRANSDUCER

(71) Applicants: Sung Q LEE, Daejeon (KR); Gunn Hwang, Daejeon (KR)

(72) Inventors: Sung Q LEE, Daejeon (KR); Gunn Hwang, Daejeon (KR)

(73) Assignee: Electronics and Telecommunications Research Institute, Daejeon (KR)

(21) Appl. No.: 13/558,259

(22) Filed: Jul. 25, 2012

(30) Foreign Application Priority Data
Jul. 29, 2011 (KR) 10-2011-0075658

(51) Int. Cl. B06B 3/04; B06B 1/06

(52) U.S. Cl. 367/189

(57) ABSTRACT

Disclosed is a high directive ultrasonic transducer that can concentrate a radiated ultrasonic wave in one direction by making an orientation angle of the radiated ultrasonic wave small in an ultrasonic transducer having a planar radiation plate structure, which has high radiation efficiency in an air medium. The high directive ultrasonic transducer according to the present disclosure includes a planar radiation plate configured to radiate an ultrasonic wave into a medium; a driving unit configured to vibrate the radiation plate in a higher order mode of a secondary order or more by applying predetermined force to a bottom surface of the radiation plate; and a matching layer formed in a height corresponding to 1/4 of an ultrasonic wavelength in the medium, in a part having a positive vibration velocity on a top surface of the radiation plate.

### CROSS-REFERENCE TO RELATED APPLICATIONS

This application is based on and claims priority from Korean Patent Application No. 10-2011-0075658, filed on Jul. 29, 2011, with the Korean Intellectual Property Office, the present disclosure of which is incorporated herein in its entirety by reference.

### TECHNICAL FIELD

The present disclosure relates to a high directive ultrasonic transducer that can increase radiation efficiency and directivity of a radiated ultrasonic wave.

### BACKGROUND

Vibration generated from an ultrasonic transducer vibrates a medium through an interaction with the medium and an ultrasonic wave is transferred through the vibrating medium. In the case of an existing ultrasonic transducer, the ultrasonic wave is transferred in a liquid medium with high radiation efficiency. The reason is that impedances (an impedance of aluminum: approximately 13,000,000 Rayls and an impedance of water: approximately 1,500,000 Rayls) of the ultrasonic transducer (for example, aluminum) and liquid (for example, water) are easily matched with each other, and as a result, an ultrasonic transducer used in water shows a good result in efficiency and directivity performance.

However, when the medium is gas (for example, air), a difference between the impedance of the ultrasonic transducer and the impedance of air is very large (the impedance of air: approximately 415 Rayls), radiation efficiency becomes significantly lower. A research into a structure that decreases the impedance of the ultrasonic transducer is required to solve the problem.

The radiation efficiency in air can be improved by well designing a material and a structure of the ultrasonic transducer. First, as the material, a material is preferably used, which has a small impedance which is a multiple of the velocity of sound and density in the medium. That is to say, the material may include paper, silicon, rubber, or a polymer based material. However, it is very difficult to manufacture a vibration structure of tens of kHz or more which is a frequency to generate the ultrasonic wave in spite of using the materials. In particular, it is almost impossible to manufacture a vibration structure having a size of tens of MHz at tens of kHz in a primary vibration mode.

A method for decreasing an impedance through a structure of a vibration plate (radiation plate) of the ultrasonic transducer first includes a method for manufacturing the size of the vibration plate in a micro-size. As the structure of the transducer has a micro-structure, the transducer has the vibration structure of tens of kHz or tens of MHz and has a small impedance. However, although the micro-structure may have high efficiency of individual unit transducers, two problems are caused as described below. First, since the intensity of the generated ultrasonic wave is very small, a sufficient ultrasonic output can be particularly acquired only through an array-type configuration. A second problem is directivity performance. As the ultrasonic vibration plate is downsized, since a sound source is close to a point sound source and the radiated ultrasonic wave is spread evenly in all directions, the ultrasonic wave has a spherical spreading characteristic rather than the directivity performance. Although the point sound source may be required in some used fields, the directivity performance in which the ultrasonic wave concentrates in one direction is required when the transducer is generally used as a sensor, an energy transferring device and the point sound source having the micro-structure has the spherical spreading characteristic, and as a result, it is evaluated that there is no directivity characteristic. In the end, a radiation plate having a predetermined size should be formed and used by configuring the micro-structure in the form of a plurality of arrays in order to achieve high directivity performance and since a process error is generated at the time of manufacturing the transducer in the micro-structure, it is substantially impossible to manufacture individual transducers constituting the array to have the same oscillation frequency and since efficiency rapidly decreases when the frequency slightly deviates from the oscillation frequency, radiation efficiency deteriorates.

FIG. 1 is a diagram illustrating a radiation characteristic of an ultrasonic transducer in the related art.

Referring to FIG. 1, the ultrasonic transducer includes a driving unit 101 generating vibration and a radiation plate 103 which is vibrated by the driving unit 101 to radiate an ultrasonic wave into a medium.

When the medium is vibrated by the radiation plate 103, a Rayleigh distance which is a distance in which the ultrasonic waves concentrate while the ultrasonic waves interfere with each other is present up to a predetermined distance and when the ultrasonic wave passes through the Rayleigh distance, the ultrasonic wave is spread while keeping the spherical radiation characteristic. In this case, it is required that the radiation plate 103 generates the ultrasonic wave by higher-mode vibration while keeping a planar structure in order to reduce an impedance while generating vibration of tens of kHz to tens of MHz.

FIGS. 2A and 2B are diagrams illustrating ultrasonic transducer having planar radiation plates structure having different thicknesses.

A radiation plate 201 of FIG. 2A has a diameter (D) of 200 mm and a thickness (t) of 8.4 mm and a radiation plate 203 of FIG. 2B has a diameter (D) of 200 mm and a thickness (t) of 3.3 mm. In both cases, a frequency of the ultrasonic wave is designed to have 70 kHz and force F applied to the radiation plates 201 and 203 is 19.6 N and distributions of a vibration velocity on cross sections of the radiation plates 201 and 203 are displayed together.

A method for acquiring an ultrasonic wave having a predetermined frequency is various and a radiation plate structure to acquire an ultrasonic wave having 70 kHz is achieved by primary vibration, a radiation plate structure to acquire the ultrasonic wave having 70 kHz is achieved by 4.5-th vibration as illustrated in FIG. 2A, and a radiation plate structure to acquire the ultrasonic wave having 70 kHz is achieved by 6-th vibration as illustrated in FIG. 2B.

However, in the case of an average impedance Z_{avc} which is a ratio of an average velocity generated throughout the radiation plate to the force applied in each case, the impedance decreases as a vibration order increases. That is, higher-mode vibration of a radiation plate having a small thickness has a lower impedance than lower-mode vibration of a radiation plate having a large thickness and a radiation plate having a predetermined diameter and a predetermined thickness may have an impedance similar as an impedance in air. When the impedance of the ultrasonic transducer has a value similar as the medium, the radiation efficiency increases and as described above, a higher-mode radiation plate structure illustrated in FIG. 2B has higher radiation efficiency than that of FIG. 2A.

However, when the radiation plate is vibrated in the higher order mode, a radiation characteristic of the ultrasonic wave has a radiation characteristic in which the ultrasonic wave is evenly spread at all angles rather than concentrates in one direction. FIG. 3 is a diagram illustrating a characteristic in which the ultrasonic wave is radiated from the radiation plate that vibrates in the higher order mode through numerical analysis. As illustrated in FIG. 3, the ultrasonic wave is distributively radiated in multiple directions rather than radiated in one direction on the higher-mode radiation plate.

In more detail, when the radiation plate that vibrates in the higher order mode vibrates, a partial surface of the radiation plate vibrates in any one direction and a partial surface of the radiation plate vibrates in another direction, and as a result, both partial surfaces vibrate with different phases. In FIGS. 2A and 2B, there's a part which moves upward, and a part which moves downward. Therefore, since vibration phases of the radiation plate cross each other, the ultrasonic wave is not evenly spread in any one direction but spread in all directions. Therefore, it is difficult to acquire a high directivity characteristic.

### SUMMARY

The present disclosure has been made in an effort to provide a high directive ultrasonic transducer that can concentrate a radiated ultrasonic wave in one direction by making an orientation angle of the radiated ultrasonic wave small in an ultrasonic transducer having a planar radiation plate structure, which has high radiation efficiency. In particular, the present disclosure has been made in an effort to increase ultrasonic wave radiation efficiency and directivity to a medium having a low impedance, such as air.

An exemplary embodiment of the present disclosure provides a high directive ultrasonic transducer, including: a planar radiation plate configured to radiate an ultrasonic wave into a medium; a driving unit configured to vibrate the radiation plate in a higher order mode of a secondary order or more by applying predetermined force to a bottom surface of the radiation plate; and a matching layer formed in a height corresponding to 1/4 of an ultrasonic wavelength in the medium, in a part having a positive vibration velocity on a top surface of the radiation plate.

The radiation plate may be made of aluminum and the matching layer may be made of a silicon, polymethyl methacrylate (PMMA), or polymer based material.

An impedance of the matching layer may have a value between an impedance of the radiation plate and an impedance of the medium.

The driving unit may include a piezoelectric thin-film driver coupled to a bottom surface of the radiation plate in a thin-film form and in the piezoelectric thin-film driver, a power voltage electrode may be formed on a bottom surface of a thin film in a part where the matching layer is formed on the radiation plate and a ground voltage electrode may be formed on a bottom surface of the thin film in the rest of the part.

Another exemplary embodiment of the present disclosure provides a high directive ultrasonic transducer, including: a planar radiation plate configured to radiate an ultrasonic wave into a medium; a driving unit configured to vibrate the radiation plate in a higher order mode of a secondary order or more by applying predetermined force to a bottom surface of the radiation plate; a first matching layer formed in a height corresponding to 1/4 of an ultrasonic wavelength in the medium, in a part having a positive vibration velocity on a top surface of the radiation plate; and a second matching layer formed in a height corresponding to 3/4 of an ultrasonic wavelength in the medium, in a part having a positive vibration velocity on a top surface of the radiation plate.

According to exemplary embodiments of the present disclosure, an ultrasonic transducer having high radiation efficiency to a medium having a low impedance, such as air and a high directivity characteristic can be implemented with a small thickness by forming an uneven matching layer on a radiation plate that vibrates in a higher order mode to suit a vibration mode.

Further, high driving efficiency can be acquired by implementing a driving unit coupled to the radiation plate as a piezoelectric thin-film driver.

The foregoing summary is illustrative only and is not intended to be in any way limiting. In addition to the illustrative aspects, exemplary embodiments, and features described above, further aspects, exemplary embodiments, and features will become apparent by reference to the drawings and the following detailed description.

### BRIEF DESCRIPTION OF THE DRAWINGS

FIG. 1 is a diagram illustrating a radiation characteristic of an ultrasonic transducer in the related art.

FIGS. 2A and 2B are diagrams illustrating ultrasonic transducer having planar radiation plate structures having different thicknesses.

FIG. 3 is a diagram illustrating a characteristic in which an ultrasonic wave is radiated from the radiation plate that vibrates in the higher order mode.

FIG. 4 is a configuration diagram of a high directive ultrasonic transducer according to an exemplary embodiment of the present disclosure.

FIG. 5 is a diagram illustrating vibration velocity distributions of a radiation plate with and without a matching layer.

FIG. 6 is a diagram illustrating a radiation characteristic of a high directive ultrasonic transducer according to the present disclosure.

FIG. 7 is a configuration diagram of a high directive ultrasonic transducer according to another exemplary embodiment of the present disclosure.

FIG. 8 is a diagram illustrating an exemplary embodiment of a piezoelectric thin-film driver in which the driving unit is coupled to the radiation plate in a thin film form.

FIGS. 9A to 9C are diagrams illustrating various forms of the radiation plate coupled with the matching layers.

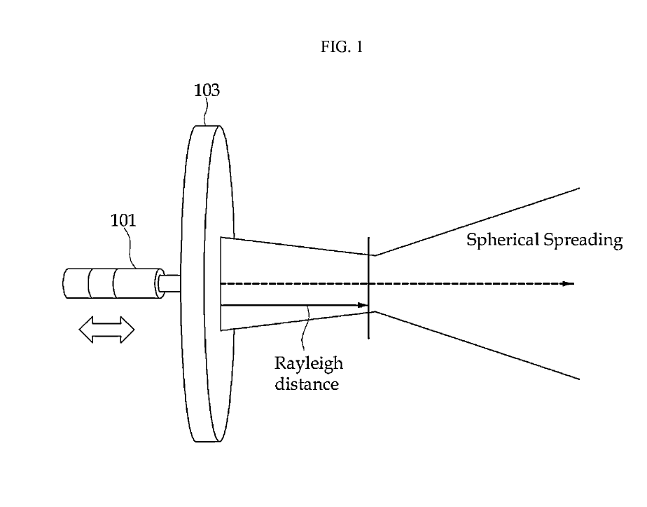

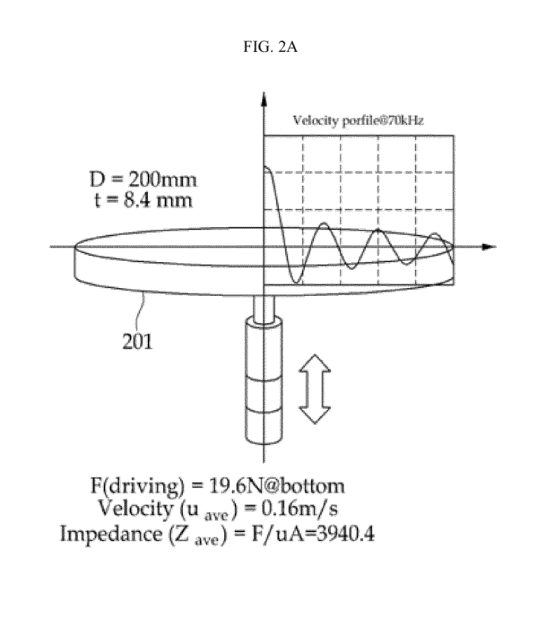

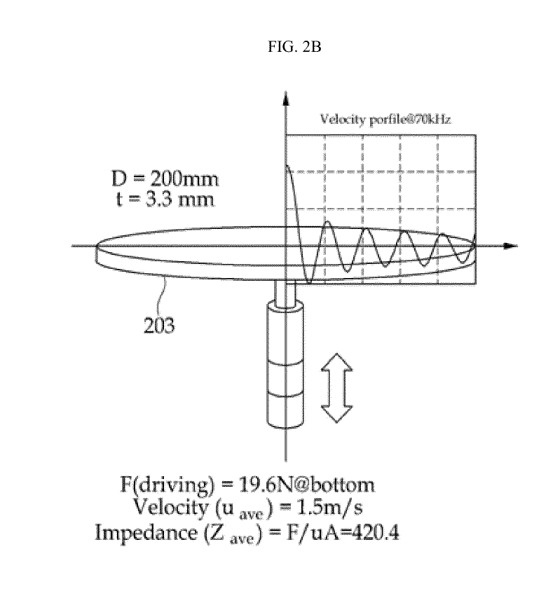

### DETAILED DESCRIPTION

In the following detailed description, reference is made to the accompanying drawing, which form a part hereof. The illustrative exemplary embodiments described in the detailed description, drawing, and claims are not meant to be limiting. Other exemplary embodiments may be utilized, and other changes may be made, without departing from the spirit or scope of the subject matter presented here.

The aforementioned objects, features, and advantages will be described in detail with reference to the accompanying drawings, and as a result, the spirit of the present disclosure will be able to be easily implemented by those skilled in the art. In describing the present disclosure, well-known constructions or functions will not be described in detail when it is judged that they may unnecessarily obscure the understanding of the present disclosure. Hereinafter, exemplary embodiments of the present disclosure will be described in detail with reference to the accompanying drawings.

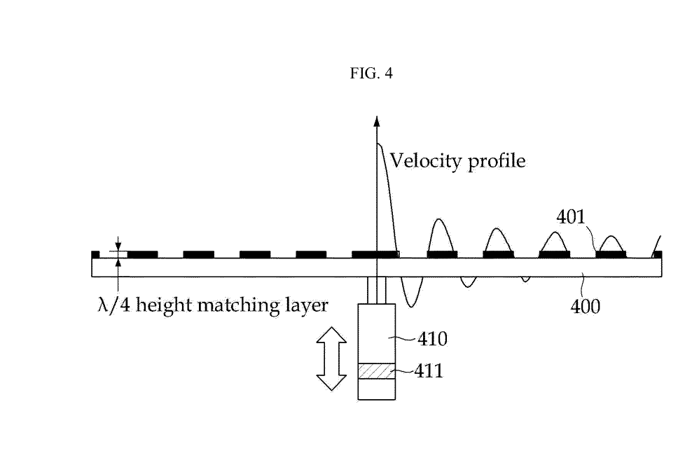

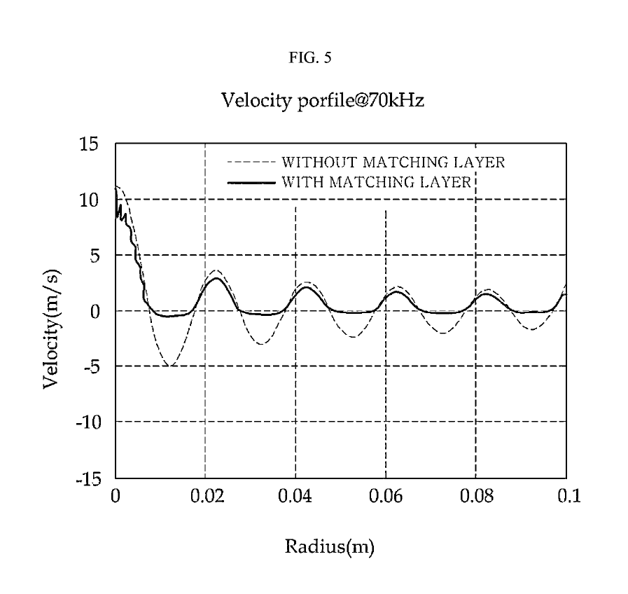

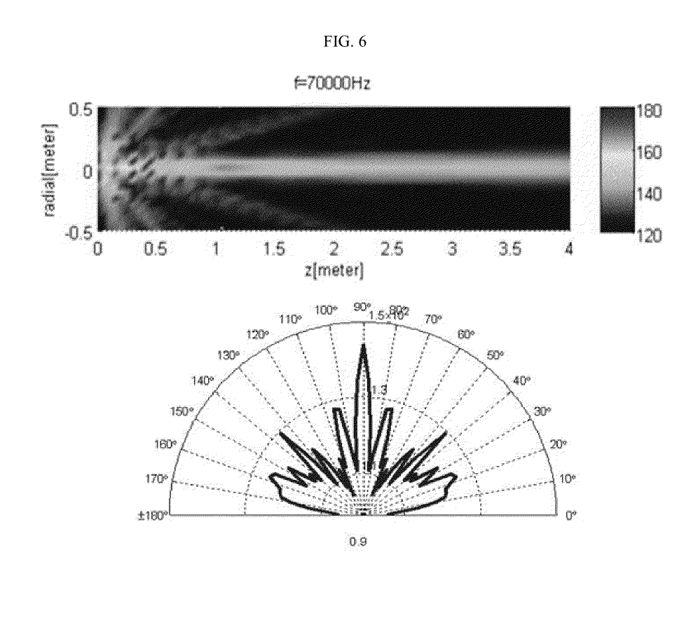

FIG. 4 is a configuration diagram of a high directive ultrasonic transducer according to an exemplary embodiment of the present disclosure. FIG. 5 is a diagram illustrating vibration velocity distributions of a radiation plate 400 with and without a matching layer 401. FIG. 6 is a diagram illustrating a radiation characteristic of a high directive ultrasonic transducer according to the present disclosure.

Referring to FIG. 4, a high directive ultrasonic transducer according to the exemplary embodiment of the present disclosure includes a planar radiation plate 400 radiating an ultrasonic wave into a medium, a driving unit 410 vibrating the radiation plate 400 in a higher order mode of a secondary order or more by applying predetermined force to a bottom surface of the radiation plate 400, and a matching layer 401 formed in a height corresponding to 1/4 of an ultrasonic wavelength in the medium, in a part having a positive vibration velocity on a top surface of the radiation plate 400.

The present disclosure presents an ultrasonic transducer coupled with the matching layer 401 having the height corresponding to 1/4 of the ultrasonic wavelength in the medium to suit the vibration mode of the radiation plate 400. Herein, the matching layer 401 may have an impedance lower than a material of the radiation plate 400 and higher than the medium. In general, since the radiation plate 400 is made of aluminum and aluminum has a much higher impedance, the impedance is decreased through a structure having plane plate vibration in the higher order mode as illustrated in FIG. 4.

In the plane plate vibration in the higher order mode, the radiation plate 400 vibrates so that phases cross each other in a stop state. In FIG. 4, a part having a positive vibration velocity and a part having a negative vibration velocity are present as illustrated in a sine wave form. This is generated because force to make the sum of upward force and downward force be 0 is partially distributed in order to achieve a balance of force during oscillation.

The matching layer 401 is coupled to only a part having the positive vibration velocity on the top surface of the radiation plate 400. When the matching layer 401 having the height corresponding to 1/4 of the ultrasonic wavelength is coupled to the radiation plate 400, a velocity in a part with the matching layer is maintained to a value similar as a velocity in a part without the matching layer, but the velocity becomes very low in the part without the matching layer as illustrated in FIG. 5. When force is applied to the bottom of the radiation plate 400, the radiation plate 400 is also vibrated, the vibrated force of the radiation plate 400 is transferred to the matching layer 401, such that force is applied to the radiation plate 400 in an opposite direction by a reaction as large as the force applied to the matching layer 401. Therefore, the velocity is decreased by repulsive force, and as a result, the radiation plate 400 has a vibration velocity distribution illustrated in FIG. 5.

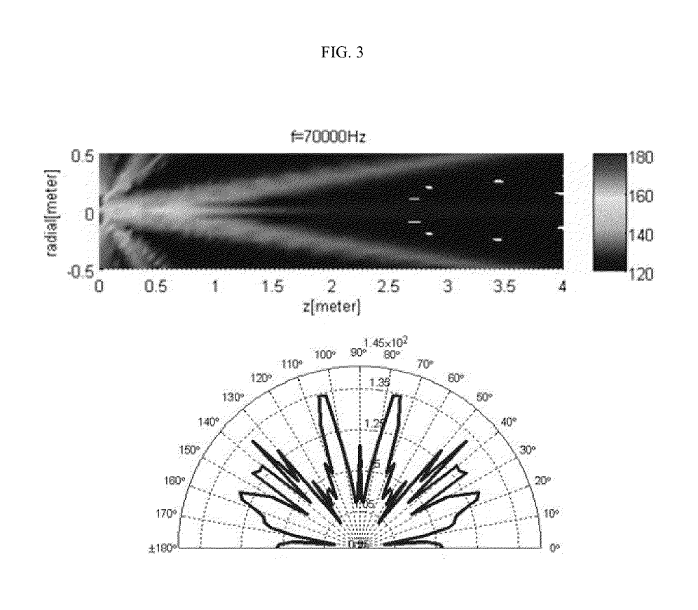

The velocity distribution of the radiation plate 400 has a direct influence on the radiation characteristic of the ultrasonic wave. In a structure in which the radiation plate does not have the matching layer as illustrated in FIG. 3, the radiated wave is spread in various directions without directivity in a predetermined direction, but in the present disclosure, the matching layer 401 having the height corresponding to 1/4 of the wavelength height of the ultrasonic wave is formed, such that the ultrasonic wave has high directivity as illustrated in FIG. 6. That is, the ultrasonic wave is not distributed up to a long distance but concentratively radiated. The reason is that a resulting available velocity distribution is achieved in only one direction (an upper direction in FIG. 6), such that the radiation plate 400 performs vibration such as primary piston vibration.

Meanwhile, the height may be very small for each medium forming the matching layer 401. Therefore, the ultrasonic transducer with high directivity may be implemented without changing a unique vibration mode. The matching layer 401 may be made of silicon, or a polymethyl methacrylate (PMMA) or polymer based material.

For example, when the radiation plate 400 is made of a circular aluminum material having a diameter 20 mm and has a thickness of 8.4 mm, the radiation plate 400 may be driven at a frequency of 70 kHz. In this case, a sound velocity in the aluminum material is 5150 m/s and the 1/4 wavelength height is approximately 18 mm at 70 kHz, but when the matching layer 401 is made of the polymer based silicon, a characteristic impedance is approximately 7200 R(Rayls) which is a medium value between an impedance of aluminum (13.9 MR) and an impedance of air (415 R) and the sound velocity is 58 m/s. In this case, the 1/4 wavelength which is the height of the matching layer 401 is approximately 0.18 mm. The value depends on the material and the wavelength is deduced by dividing the sound velocity in the material by a driving frequency and thus, a thinner matching layer may be acquired.

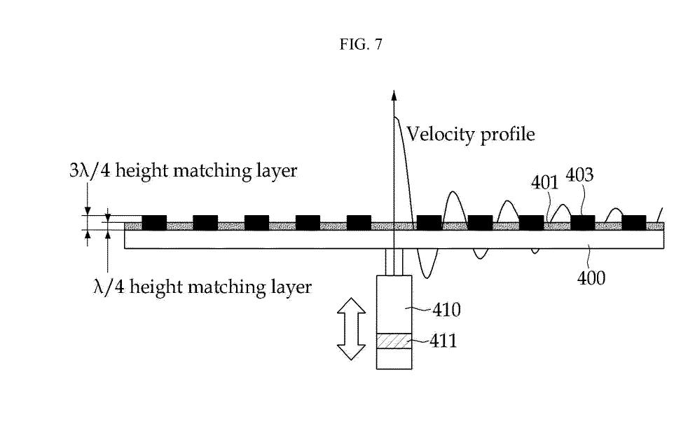

FIG. 7 is a configuration diagram of a high directive ultrasonic transducer according to another exemplary embodiment of the present disclosure.

Referring to FIG. 7, the high directive ultrasonic transducer according to the another exemplary embodiment of the present disclosure includes a planar radiation plate 400 radiating an ultrasonic wave into a medium, a driving unit 410 vibrating the radiation plate 400 in a higher order mode of a secondary order or more by applying predetermined force to a bottom surface of the radiation plate 400, a first matching layer 401 formed in a height corresponding to 1/4 of an ultrasonic wavelength in the medium, in a part having a positive vibration velocity on a top surface of the radiation plate 400, and a second matching layer 403 formed in a height corresponding to 3/4 of an ultrasonic wavelength in the medium, in a part having a negative vibration velocity on a top surface of the radiation plate 400.

The configuration of FIG. 7 may be considered based on the configuration of FIG. 4. Since velocity values in parts without the first matching layer 401 still have a bad influence on the directivity of the ultrasonic wave, when the second matching layer 403 having the height corresponding to 3/4 of the ultrasonic wavelength is formed in areas where velocity phases are opposite to each other, vibration having an inverse phase to the vibration of the radiation plate 400 is generated. Therefore, the vibration velocity distribution of the radiation plate 400 is formed in one direction, and as a result, directivity is further increased.

The structure of the radiation plate 400 may be designed in the form of a small thickness, such that deterioration of the directivity characteristic in which the vibration of the radiation plate 400 intersects upward/downward may be prevented while impedance matching with the medium is smooth.

Meanwhile, the matching layers 401 and 403 coupled to the radiation plate 400 should be fabricated with the thicknesses thereof accurately designed. In order to fabricate the matching layers 401 and 403 with the accurate thicknesses, the matching layers 401 and 403 may be bonded onto the radiation plate 400 in a sheet form and thereafter, patterned or a fluid type material may be spin-coated on the radiation plate 400 and thereafter, patterned to suit the vibration velocity distribution.

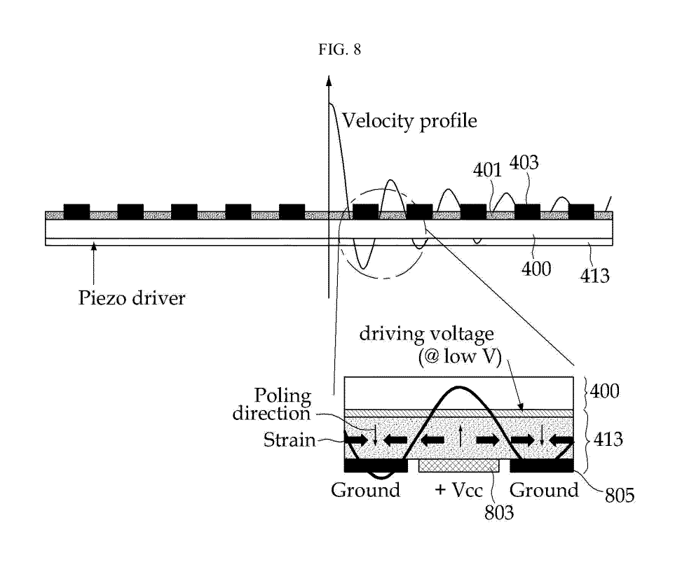

The driving unit 410 may be configured to include a piezoelectric driver 411 and actual force and variance (velocity) for the vibration of the radiation plate 400 are applied to the center of the bottom surface of the radiation plate 400. The piezoelectric driver 411 may be coupled to the radiation plate 400 in a sandwich structure as illustrated in FIGS. 4 and 7 or coupled to the radiation plate 400 in a thin-film structure. Hereinafter, it will be described in FIG. 8.

FIG. 8 is a diagram illustrating an exemplary embodiment of a piezoelectric thin-film driver 413 in which the driving unit 410 is coupled to the radiation plate 400 in a thin film form.

When the piezoelectric thin-film driver 413 is coupled to the bottom surface of the radiation plate 400, an electrode is disposed in one or two parts in the case where the piezoelectric thin-film driver 413 is generally driven in a primary or secondary mode, but in the present disclosure, an electrode structure in which electrodes 803 and 805 on the bottom surface are disposed according to the vibration phase of the radiation plate 400 may be adopted as illustrated in FIG. 8 and force is applied only in a vibration direction of the radiation plate 400 by using the electrode structure, thereby increasing driving efficiency of the piezoelectric driver. That is, the electrodes 801, 803, and 805 of a piezoelectric thin-film are patterned according to the vibration mode of the radiation plate 400. In this case, a top surface of the thin film is connected to one electrode 801 to be applied with driving voltage and a bottom surface of the thin film applies power (Vcc) voltage and ground voltage to the patterned electrodes 803 and 805, respectively. If the driving voltage is close to the ground voltage, the piezoelectric driver will contract or expand so that the piezoelectric driver has a large variance in a part where a voltage difference from Vcc is large and if the driving voltage is close to Vcc, a voltage difference from the voltage of a ground electrode is large, and as a result, the piezoelectric driver in a ground part will be driven with a large variance. When the piezoelectric thin-film driver 413 is coupled with the presented structure of the radiation plate 400, the piezoelectric thin-film driver 413 may be newly driven and such a driving method increases driving efficiency of the driver.

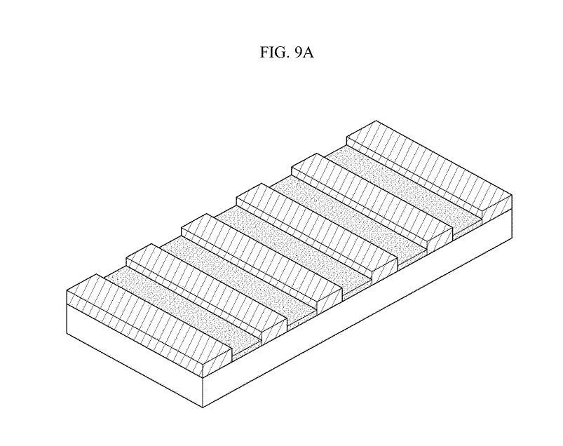

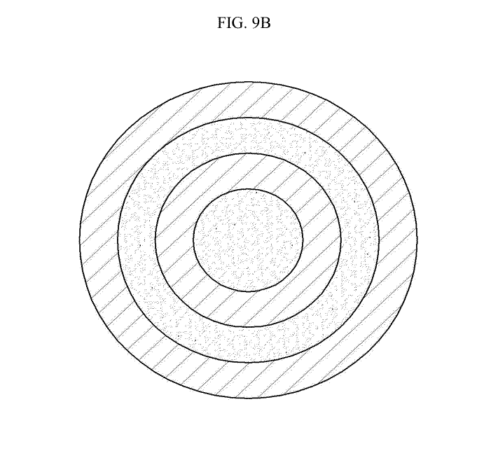

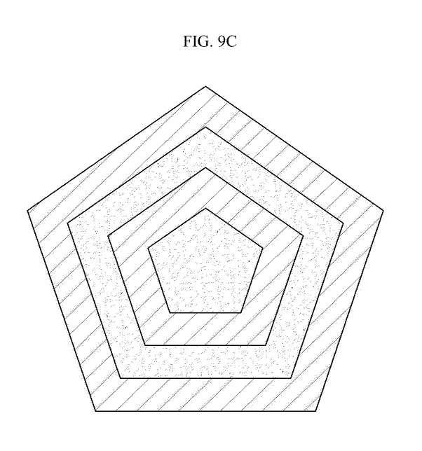

FIGS. 9A to 9C are diagrams illustrating various forms of the radiation plate 400 coupled with the matching layers 401 and 403.

As illustrated in the figures, the radiation plate 400 may have a one-dimensional primary linear symmetric form (FIG. 9A), a 2-dimensional circular symmetric form (FIG. 9B), or a 2-dimensional polygonal form (FIG. 9C).

The high directive ultrasonic transducer according to the present disclosure may be used in various ultrasonic sensors used in a sensor node for a ubiquitous sensor network (USN), a TV, a portable terminal, and a robot and may be used in high-efficiency, high-directive wireless power transmitting apparatuses configured together with an ultrasonic receiving apparatus.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A high directive ultrasonic transducer, comprising:
a planar radiation plate configured to radiate an ultrasonic wave into a medium;
a driving unit configured to vibrate the radiation plate in a higher order mode of a secondary order or more by applying predetermined force to a bottom surface of the radiation plate; and
a matching layer formed in a height corresponding to 1/4 of an ultrasonic wavelength in the medium, in a part having a positive vibration velocity on a top surface of the radiation plate.

2. The high directive ultrasonic transducer of claim 1, wherein the radiation plate is made of aluminum.

3. The high directive ultrasonic transducer of claim 1, wherein the matching layer is made of a silicon, polymethyl methacrylate (PMMA), or polymer based material.

4. The high directive ultrasonic transducer of claim 1, wherein an impedance of the matching layer is smaller than an impedance of the radiation plate and larger than an impedance of the medium.

5. The high directive ultrasonic transducer of claim 1, wherein the matching layer is fabricated by patterning after bonded in a sheet form onto the radiation plate, or fabricated by spin-coating a fluid type material on the radiation plate and patterning the spin-coated material.

6. The high directive ultrasonic transducer of claim 1, wherein the driving unit includes a piezoelectric thin-film driver coupled to a bottom surface of the radiation plate in a thin-film form.

7. The high directive ultrasonic transducer of claim 6, wherein in the piezoelectric thin-film driver, a power voltage electrode is formed on a bottom surface of a thin film in a part where the matching layer is formed on the radiation plate and a ground voltage electrode is formed on a bottom surface of the thin film in the rest of the part.

8. The high directive ultrasonic transducer of claim 1, wherein the radiation plate is formed in a 1-dimensional linear symmetric form, a 2-dimensional circular symmetric form, or a 2-dimensional polygonal form.

9. A high directive ultrasonic transducer, comprising:
a planar radiation plate configured to radiate an ultrasonic wave into a medium;
a driving unit configured to vibrate the radiation plate in a higher order mode of a secondary order or more by applying predetermined force to a bottom surface of the radiation plate;
a first matching layer formed in a height corresponding to 1/4 of an ultrasonic wavelength in the medium, in a part having a positive vibration velocity on a top surface of the radiation plate; and
a second matching layer formed in a height corresponding to 3/4 of an ultrasonic wavelength in the medium, in a part having a positive vibration velocity on a top surface of the radiation plate.

10. The high directive ultrasonic transducer of claim 9, wherein the radiation plate is made of aluminum and the first and second matching layers are made of a silicon, polymethyl methacrylate (PMMA), or polymer based material.

11. The high directive ultrasonic transducer of claim 9, wherein impedances of the first and second matching layers are smaller than an impedance of the radiation plate and larger than an impedance of the medium.

12. The high directive ultrasonic transducer of claim 9, wherein the first and second matching layers are fabricated by patterning after bonded in a sheet form onto the radiation plate, or fabricated by spin-coating a fluid type material on the radiation plate and patterning the spin-coated material.

13. The high directive ultrasonic transducer of claim 9, wherein the driving unit includes a piezoelectric thin-film driver coupled to a bottom surface of the radiation plate in a thin-film form.

14. The high directive ultrasonic transducer of claim 13, wherein in the piezoelectric thin-film driver, a power voltage electrode is formed on a bottom surface of a thin film in a part where the first matching layer is formed on the radiation plate and a ground voltage electrode is formed on the bottom surface of the thin film in a part where the second matching layer is formed.
